(19) United States
(12) Patent Application Publication
(10) Pub. No.: US 2020/0286007 A1
(43) Pub. Date: Sep. 10, 2020

(54) METHODS AND SYSTEMS FOR REAL-TIME TRAVEL JOURNEY CREATION FOR ASPIRING AND SEASONED TRAVELERS

(71) Applicant: Mariam TAREEN, San Jose, CA (US)

(72) Inventor: Mariam TAREEN, San Jose, CA (US)

(21) Appl. No.: 16/809,555

(22) Filed: Mar. 5, 2020

Related U.S. Application Data
(60) Provisional application No. 62/813,768, filed on Mar. 5, 2019.

(51) Int. Cl. G06Q 10/02; G06Q 50/00

(52) U.S. Cl. CPC G06Q 10/025; G06Q 50/01

(57) ABSTRACT

Methods and systems for real-time travel journey creation for aspiring and seasoned travelers are described. The method includes receiving journey details associated with journey from traveler to initiate creation of travel journey. The journey details include primary journey details. The method includes facilitating updating of journey details with secondary journey details. The method includes storing updated journey details. The updated journey details include primary and secondary journey details. The method includes creating travel journey for traveler based on updated journey details. The method includes sharing travel journey with profiles of individuals selected by traveler. The method includes receiving journey requirement input from aspiring traveler. The method includes accessing one or more travel journeys relevant for aspiring traveler from database based in part on journey requirement input. The method further includes electronically creating custom itinerary for aspiring traveler based in part on journey requirement input and one or more travel journeys.

### TECHNICAL FIELD

Embodiments of the disclosure relate generally to a field of travel and, more particularly to, methods and systems for real-time travel journey creation for aspiring and seasoned travelers.

### BACKGROUND

Traveling is an extraordinary experience that every person needs. It gives knowledge and a new perspective about life as traveling allows a person to learn more about the world and transform his attitude for the better. Further, traveling allows people to experience different cultures that can be enlightening and educational. Whether the focus is on exploration, humanitarian service or simply finding a quiet place, travel can be both inspiring, as well as be inspired.

Today, the tourism industry has improved with the onset of several tourist websites. A large number of travelers are interested in sharing their experiences and captured photographs for reference to other people. Hence, it is important to record the traveler's experience.

Currently, travel sites who offer travel plans have observed that a travel cart abandonment rate is around 82% which means 82% people who are planning to travel end up leaving the travel cart without completing their bookings. And the main reason behind this high cart abandonment rate is people require more information so they need to ask from friends and family for information before continuing with bookings.

However, there is no single platform for travelers to record and save a travel journey that includes all aspects of the journey. Travelers have to share updates on multiple social media platforms. Another issue is that people cannot view the content updated from the travelers in real-time. A traveler may use a communication device such as a cellular mobile phone to send content to other people. In this way, the recipient would only receive one file at a time. At times, the content may be lost in a cluster of social media feeds.

Further, current social media platforms do not allow users to add/remove individuals only for a certain journey. They do not offer discretion and create an uncomfortable situation of exposing personal information between the individuals while sharing updates which further leads to the danger of privacy violation.

Additionally, aspiring travelers are not provided with a single platform to get all the tips on traveling. There is no end to end itinerary to help the aspiring travelers to fulfill their ambition to travel to new places.

In light of the above discussion, there is a need for methods and systems that enable travelers to record their travel journey which includes all aspects of the journey along with providing end to end itinerary to aspiring travelers and thereby reducing the travel cart abandonment rate.

### SUMMARY

Various embodiments of the present disclosure provide methods and systems for real-time travel journey creation for aspiring and seasoned travelers.

In an embodiment, a method is disclosed. The method includes receiving journey details associated with a journey from a traveler device associated with a traveler to initiate creation of a travel journey. The journey details include primary journey details. The method includes facilitating updating of the journey details with secondary journey details by the traveler. The method includes storing updated journey details. The updated journey details include the primary journey details and the secondary journey details. The method includes creating the travel journey for the traveler based on the updated journey details. The method includes sharing the travel journey with profiles of one or more individuals selected by the traveler. The method includes receiving journey requirement input from an aspiring traveler. The method includes accessing one or more travel journeys relevant for the aspiring traveler from a database based in part on the journey requirement input. The method further includes electronically creating a custom itinerary for the aspiring traveler based in part on the journey requirement input and the one or more travel journeys.

In another embodiment, a server system is disclosed. The server system includes a memory to store instructions and a processor to execute the stored instructions in the memory and thereby cause the server system to receive journey details associated with a journey from a traveler device associated with a traveler to initiate creation of a travel journey. The journey details include primary journey details. The server system is further configured to facilitate updating of the journey details with secondary journey details by the traveler. The updated journey details include the primary journey details and the secondary journey details. The server system is further configured to store updated journey details. The server system is further configured to create the travel journey for the traveler based on the updated journey details. The server system is further configured to share the travel journey with profiles of one or more individuals selected by the traveler. The server system is further configured to receive journey requirement input from an aspiring traveler. The server system is further configured to access one or more travel journeys relevant for the aspiring traveler from a database based in part on the journey requirement input. The server system is further configured to electronically create a custom itinerary for the aspiring traveler based in part on the journey requirement input and the one or more travel journeys.

In yet another embodiment, a system is disclosed. The system includes a database, a user interface (UI) module, a traveler account management module, an update management module, a travel journey creation module, a reward management module, an itinerary creation engine and a processing module. The database is configured to store journey details associated with a plurality of travel journeys created by a plurality of travelers. The UI module is in communication with the database. The UI module is configured to present one or more UIs for facilitating creation of travel journey for each traveler, for receiving journey requirement from each aspiring traveler and for presenting custom itinerary to each aspiring traveler. The traveler account management module is in communication with the UI module and the database. The traveler account management module is configured to create and manage traveler profiles, aspiring traveler profiles and profiles of one or more individuals. The travel journey creation module is in communication with the database, UI module and the traveler account management module. The travel journey creation module is configured to create travel journeys based on the primary and the secondary journey details provided by the each traveler. The itinerary creation engine is in communication with the database and the UI module. The itinerary creation engine is configured to create the custom itinerary for each aspiring traveler based in part on the received journey requirement input and one or more travel journeys stored in the database.

### BRIEF DESCRIPTION OF THE FIGURES

For a more complete understanding of example embodiments of the present technology, reference is now made to the following descriptions taken in connection with the accompanying drawings in which:

FIG. 1 is an illustration of an environment, related to at least some embodiments of the present disclosure;

FIG. 2 is a block diagram of a system for creating real-time travel journeys for seasoned and aspiring travelers, in accordance with an example embodiment;

FIG. 3 is a flow diagram for performing registration of a new user of a social journaling platform, in accordance with an example embodiment;

FIG. 4 is a schematic representation illustrating preferences of a registered user, in accordance with an example embodiment;

FIG. 5 is a flow diagram for setting preferences for a travel journey shared by a traveler to an individual, in accordance with another example embodiment;

FIG. 6 is a flow diagram for recording the travel journey, in accordance with an example embodiment;

FIG. 7 is a flow diagram for searching travel journeys, in accordance with an example embodiment;

FIG. 8 is a schematic diagram depicting role of each user of the social journaling platform, in accordance with an example embodiment;

FIG. 9 is a schematic representation of a use case diagram of high-level functions performed by users of the social journaling platform, in accordance with an example embodiment;

FIG. 10A is a schematic representation of a persona of a seasoned traveler, in accordance with an example embodiment;

FIG. 10B is a schematic representation of a persona of an aspiring traveler, in accordance with an example embodiment

FIG. 11 is a flowchart illustrating a method for real-time travel journey creation for aspiring and seasoned traveler, in accordance with an example embodiment;

FIG. 12 is an example representation of a user interface (UI) depicting a travel journey creation page displayed to a user of the social journaling platform, in accordance with another example embodiment;

FIG. 13A is an example representation of a UI depicting a secondary detail page displayed to the user of the social journaling platform, in accordance with an example embodiment;

FIG. 13B is an example representation of a UI depicting a more information page displayed to the user of the social journaling platform, in accordance with an example embodiment;

FIG. 14A is an example representation of a UI depicting a traveler profile page displayed to the user of the social journaling platform, in accordance with an example embodiment;

FIG. 14B is an example representation of a UI depicting a journeys page displayed to the user of the social journaling platform, in accordance with an example embodiment;

FIG. 14C is an example representation of a UI depicting a country traveled page displayed to the user of the social journaling platform, in accordance with an example embodiment;

FIG. 14D is an example representation of a UI depicting a traveler inspired page displayed to the user of the social journaling platform, in accordance with an example embodiment;

FIG. 14E is an example representation of a UI depicting a conversation page displayed to the user of the social journaling platform, in accordance with an example embodiment;

FIG. 14F is an example representation of a UI depicting a save page displayed to the user of the social journaling platform, in accordance with an example embodiment;

FIG. 15 is an example representation of a UI depicting a journey page displayed to the user of the social journaling platform, in accordance with an example embodiment;

FIG. 16 is a block diagram of an electronic device capable of implementing the various embodiments of the present disclosure; and

FIG. 17 is a block diagram of a server system of FIG. 1 in which the social journaling platform may be stored, in accordance with an example embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### Overview

Various example embodiments of the present disclosure provide methods and systems for creating real-time travel journeys for seasoned and aspiring travelers.

A social journaling platform is provided for creating real-time travel journeys for seasoned and aspiring travelers. The social journaling platform provides User Interfaces (UIs) that helps in the creation of a travel journey for a traveler who wants to record and save travel journey that includes all aspects of that travel journey. The social journaling platform first receives basic/primary journey details associated with the journey, such as the name of a journey, starting date of the journey and starting location of the journey from the traveler for starting tracking of the journey. The journey details are further updated by the traveler with additional details associated with the journey which includes information about events that the traveler has attended during the journey, pictures taken during the journey, videos, audios, ratings of places visited during the journey, travel mode (by plane, ship, train, bus, car or walk), distance covered, time spent on travel, destination information, dates, journey experience, travel type (solo or group) and total expenditure on journey. Once all the journey details are provided by the traveler, a travel journey is created by the social journaling platform for the traveler. The created travel journey is displayed to one or more aspiring travelers who want to travel to and know more about a location that is visited by the traveler in the created travel journey.

The social journaling platform sends notifications of updates performed on the travel journeys to one or more individuals who are selected by the traveler for viewing the travel journey posted by the traveler. The social journaling platform also creates a custom itinerary for aspiring travelers based on the requirement of the aspiring travelers.

The social journaling platform determines one or more seasoned travelers from the plurality of travelers based on predefined criteria and reward the seasoned travelers with one or more gifts.

The term ‘traveler’ here refers to a person who is making a journey from place to place through land, air or water. The term ‘aspiring travelers’ here refers to persons who are planning to travel. The term ‘seasoned travelers’ here refers to the persons who have traveled a lot. The terms ‘individual’ and ‘viewer’ have been used interchangeably throughout the description and refer to a person who is allowed to see travel journeys posted by the traveler.

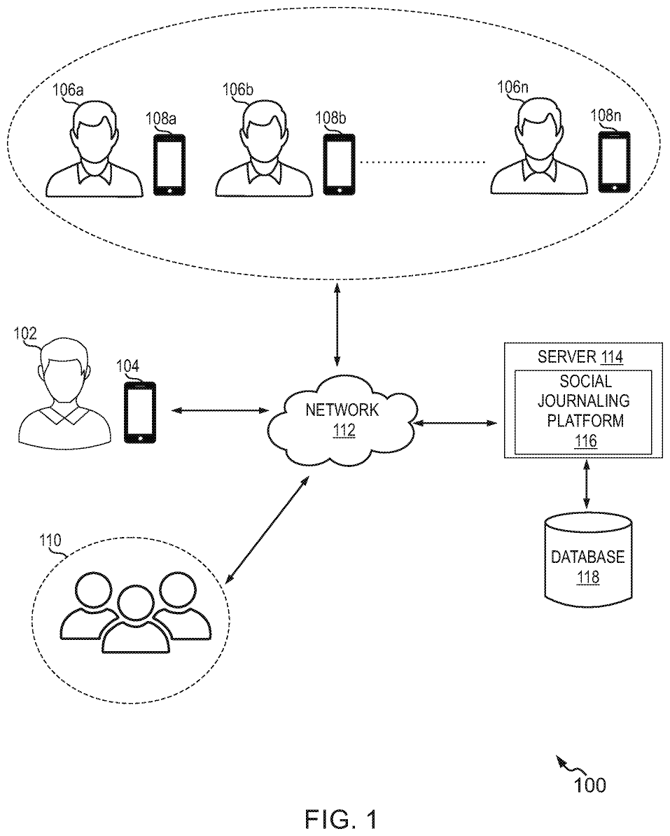

FIG. 1 is an illustration of an environment 100 related to at least some example embodiments of the present disclosure. The environment 100 includes, but is not limited to, a wireless communication network (e.g., a network 112) that connects entities such as, a traveler 102, a plurality of aspiring travelers 106a to 106n, a group of individuals 110 and a server 114. The traveler is depicted to be associated with an electronic device 104 (hereinafter referred to as ‘traveler device 104’). It should be noted that one traveler is shown for the sake of simplicity, there can be any number of travelers. The aspiring travelers 106a to 106n are depicted to be associated with electronic devices 108a to 108n (hereinafter referred to as ‘aspiring traveler devices 108a to 108n’), respectively. It should be noted that the aspiring travelers 106a to 106n are collectively referred to as an aspiring traveler 106 and the aspiring traveler devices 108a to 108n are collectively referred to as an aspiring traveler device 108.

In at least one example embodiment, the traveler device 104 and the aspiring traveler device 108 are equipped with a social journaling platform 116 that facilitates the creation of real-time travel journeys for the traveler 104 and the aspiring traveler 106. The traveler device 104 and the aspiring traveler device 108 may be any communication devices having hardware components for enabling User Interfaces (UIs) of the social journaling platform 116 to be presented on the traveler device 104 and the aspiring traveler device 108. The traveler device 104 and the aspiring traveler device 108 may be capable of being connected to a wireless communication network (such as the network 112). Examples of the traveler device 104 and the aspiring traveler device 108 include a mobile phone, a smart telephone, a computer, a laptop, a PDA (Personal Digital Assistant), a Mobile Internet Device (MID), a tablet computer, an Ultra-Mobile personal computer (UMPC), a phablet computer, a handheld personal computer and the like.

In at least one example embodiment, the traveler 102 may access the social journaling platform 116 for creating a travel journey by providing journey details associated with a journey that the traveler has done in recent times. The journey details include basic information that is required for starting tracking of the journey, such as the name of journey, starting date of journey and starting location of the journey and is referred to as primary journey details. The social journaling platform 116 may enable the traveler 102 to update the journey details with secondary journey details, such as information about events that the traveler has attended during the journey, pictures taken during the journey, videos, audios, ratings of places visited during the journey, travel mode (by plane, ship, train, bus, car or walk), distance covered, time spent on travel, destination information, dates, journey experience, travel type (solo or group) and total expenditure on journey to create the travel journey. The updated journey details include both the primary journey details and the secondary journey details. The social journaling platform 116 may also enable the traveler 102 to share the travel journey with one or more individuals or group of individuals, such as the group of individuals 110. In an embodiment, the other individuals can be family and friends. The social journaling platform 116 enables the traveler 102 to curate and share their experience of the journey by creating the travel journey which can inspire other people to travel or to make plan for a journey. Further, the traveler 102 may also provide mentoring services to aspiring travelers, such as the aspiring travelers 106a to 106n using the social journaling platform 116. Additionally, the traveler 102 can earn rewards in terms of both money and perks based on a popularity of the travel journey posted by the traveler 102 using the social journaling platform 116. In an embodiment, the popularity of the travel journey is decided based on a number of views on the travel journey, number of likes and number of addition to favorites. The processor of the social journaling platform 116 is configured to quantify the factors such as the number of views on the travel journey, the number of likes and the number of addition to favorites, and can calculate a weighted sum of all these factors to determine the rewards.

In an embodiment, the aspiring travelers 106a to 106n may access the social journaling platform 116 for finding the desired travel journeys. The social journaling platform 116 enables the aspiring travelers 106a to 106n to search for a desired travel journey and then displays one or more travel journeys related to the desired travel journey. In at least one example embodiment, the search for the desired travel journey is performed using search strings. The aspiring travelers 106a to 106n may also set up to receive notifications for the matching results in case desirable results are not available/displayed at that time. The social journaling platform 116 also enables the aspiring travelers 106a to 106n to place journey requirement inputs for receiving customized itinerary. Further, the aspiring travelers 106a to 106n may access the social journaling platform 116 for communicating with one or more travel mentors registered with the social journaling platform 116 for setting one or more mentoring sessions. The aspiring travelers 106a to 106n can seek coaching on travel based on personalized criteria from the one or more travel mentors in those one or more mentoring sessions. The social journaling platform 116 may get a platform fee if the one or more mentoring sessions are booked through the social journaling platform 116. The one or more travel mentors may also get paid for taking mentoring sessions. In an embodiment, one or more travel mentors are the travelers (e.g., the traveler 102) who have opted for providing mentoring services to aspiring travelers (e.g., the aspiring travelers 106a to 106n). In at least one example embodiment, a travel mentor is a seasoned traveler.

In an embodiment, the server 114 provides a software application, herein referred to as the social journaling platform 116, in response to a request received from the traveler device 104 or the aspiring traveler devices 108a to 108n (associated with the aspiring travelers 106a to 106n, respectively) via the network 112. Examples of the network 112 include stand-alone or a combination of a local area network (LAN), a wide area network (WAN), wireless, wired, any currently existing or to be developed network that can be used for communication. More specifically, an example of the network 112 can be the Internet which may be a combination of a plurality of networks. In some embodiments, the social journaling platform 116 may be factory-installed on the traveler device 104 and the aspiring traveler devices 108a to 108n and the traveler 102 and the aspiring travelers 106a to 106n may not need to specifically request the social journaling platform 116 from the server 114.

In at least one example embodiment, the social journaling platform 116 is configured to create and record a travel journey for the traveler 102 based on the primary and the secondary journey details provided by the traveler 102. The created travel journey includes each and every detail associated with the journey which can be useful for an aspiring traveler (e.g., the aspiring traveler 106) who is also planning to travel to the same location. The social journaling platform 116 is also configured to share the updates performed on the primary journey details with profiles of the one or more individuals or the group of individuals 110 while maintaining the privacy of each profile/individual. In an embodiment, the one or more individuals or the group of individuals 110 are registered users of the social journaling platform 116 so their profiles are already present in the social journaling platform 116. In another embodiment, the one or more individuals or the group of individuals 110 are not registered users of the social journaling platform 116, so first an invite including a link to download the application is sent to the one or more individuals or the group of individuals 110 using their electronic mail (e-mail) id's or contact numbers, then the application is downloaded using the link and the profiles of the one or more individuals or the group of individuals 110 are created by the one or more individuals or the group of individuals 110 on the application.

In at least one example embodiment, the social journaling platform 116 is configured to create a traveler profile for each traveler of a plurality of travelers who are interested in sharing their journey experiences with one or more aspiring travelers. The social journaling platform 116 is also configured to accumulate each travel journey created by each traveler in their traveler profile. Further, the social journaling platform 116 is configured to facilitate the display of each traveler profile to the one or more aspiring travelers, wherein the each traveler profile includes one or more travel journeys created by each traveler.

The social journaling platform 116 is configured to display the desired travel journeys to the aspiring travelers 106a to 106n as requested by the aspiring travelers 106a to 106n. The social journaling platform 116 is also configured to create a custom itinerary for the aspiring travelers 106a to 106n based in part on the journey requirement input provided by the aspiring travelers 106a to 106n and the recorded travel journeys. Further, the social journaling platform 116 is configured to make suggestions to the aspiring travelers 106a to 106n based on the searches performed by the aspiring travelers 106a to 106n.

In an embodiment, the social journaling platform 116 is configured to determine one or more seasoned travelers from the plurality of travelers based on predefined criteria. In an embodiment, the predefined criteria can be selecting travelers who have posted the top ten most saved travel journeys. In another embodiment, the predefined criteria can be selecting travelers with the most valuable travel journeys. For instance, a travel journey becomes valuable when the travel journey is among the 2-3 journeys posted for that particular location and the traveler has provided enough details about the journey, such as which airline he has used, which booking site he has used to make bookings, which cruise line has used and which tour operator he has used etc. The social journaling platform 116 is also configured to add and display links of all the booking sites/applications that the traveler 102 has mentioned in their travel journey. In an embodiment, the links of the booking sites/applications who have agreed to pay a pre-decided amount per view to the social journaling platform 116 may be displayed on the social journaling platform 116. The amount received may also be shared with the traveler who has posted the valuable travel journey. Further, the social journaling platform 116 is configured to reward the one or more seasoned travelers with one or more gifts, such as badges, reward points, pins and merchandise for curating and sharing the journey details which helps in inspiring and convincing aspiring travelers 106a to 106n to travel.

In an example scenario, as shown in FIG. 1, the traveler 102 has visited a new country (for example, England) and wants to share his/her experience and photos captured during the trip as a reference for aspiring travelers (e.g., the aspiring traveler 106) who also wants to travel to England and to other individuals or group of individuals (e.g., the group of individuals 110). The other individuals or the group of individuals can be family members or friends with whom the traveler wants to share the happenings of the trip. The traveler 102 may use the social journaling platform 116 installed on the traveler device 104 to record every detail about the trip. For recording details, the traveler 102 needs to first create a profile for using the social journaling platform 116. Once the profile is created, the traveler 102 is allowed to record primary and secondary journey details. The social journaling platform 116, upon receiving the primary and secondary journey details, may create a travel journey for the traveler 102. The created travel journey may further be stored in a database 118 under the name of the traveler 102. The traveler 102 can then share the travel journey created on the social journaling platform 116 with other individuals or the group of individuals 110. The traveler 102 can choose a type of access from a plurality of accesses provided by the social journaling platform 116 for the created travel journey. The plurality of accesses includes, but is not limited to, selective, public and private. In the case of selective access, the travel journey can be viewed by some selected individuals only. In the case of public access, the travel journey can be viewed by everyone. In the case of private access, the travel journey can be viewed by the traveler only.

In at least one example embodiment, the aspiring traveler 106 wants to travel to England but he/she doesn't have much time to plan the trip. The aspiring traveler 106 is interested in knowing real-time experiences of people who have traveled to England. For knowing the real-time experiences, the aspiring traveler 106 may access the social journaling platform 116 on the aspiring traveler device 108 for viewing the travel journeys posted by the travelers who have traveled to England. The aspiring traveler 106 may perform a search on the social journaling platform 116 using some keywords related to England for viewing the travel journeys associated with England. In an embodiment, the aspiring traveler 106 can create a profile on the social journaling platform 116 for viewing the travel journeys. In another embodiment, the aspiring traveler 106 can view the travel journeys without creating the profile.

Upon receiving the search query, the social journaling platform 116 may display all the travel journeys related to England including the travel journey posted by the traveler 102. The aspiring traveler 106 can go through the search results to know more about England, traveling expenses, places to visit in England, etc. In an embodiment, the aspiring traveler 106 can also provide a journey requirement input to the social journaling platform 116. The journey requirement input includes the customized requirements (as per current example it can be associated with family travel to England). The social journaling platform 116, upon receiving the journey requirement input, may provide a custom itinerary to the aspiring traveler 106 based on the received journey requirement input and one or more travel journeys related to the journey requirement input stored in the database 118.

In at least one example embodiment, the aspiring traveler 106 can also chat with the traveler 102 directly for receiving mentoring services using the social journaling platform 116. For receiving mentoring services, the aspiring traveler 106 first needs to setup a meeting or a mentoring session with the traveler 102 by paying some amount using the social journaling platform 116. The aspiring traveler 106 can also opt for receiving notifications associated with a location that the aspiring traveler 106 wants to travel. The social journaling platform 116 may also provide suggestions to the aspiring traveler 106 based on his/her search history.

The social journaling platform 116 is an application resting at the server 114. In an embodiment, the server 114 is configured to manage the social journaling platform 116 and communicate with devices, such as the traveler and aspiring traveler devices 104 and 108 using the network 112. The social journaling platform 116 may be accessed through the web via the network 112. In an embodiment, social journaling platform 116 may be accessed through the web using Internet.

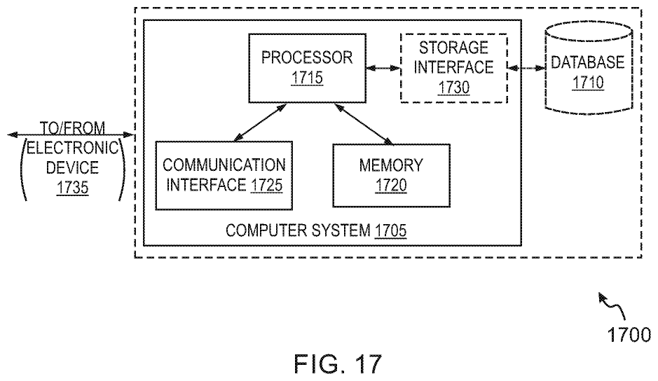

It is noted that the instructions (or the executable code) configuring the social journaling platform 116 are stored in a memory of the server 114, and the instructions are executed by a processor (for example, a single-core or a multi-core processor) included within the server 114, as is exemplarily shown with reference to FIG. 17. Accordingly, even though the various functionalities for creating real-time travel journeys for seasoned and aspiring travelers are explained with reference to or being performed by the social journaling platform 116, it is understood that the processor in conjunction with the code in the memory is configured to execute the various tasks as enabled by the instructions of the social journaling platform 116.

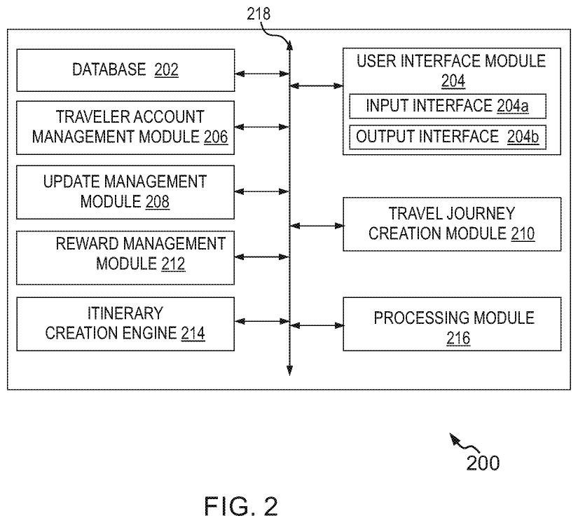

The various components of the social journaling platform 116 are further explained with reference to FIG. 2.

FIG. 2 is a block diagram of a system 200 for creating real-time travel journeys for seasoned and aspiring travelers, in accordance with an example embodiment. The system 200 may be embodied in a server, such as the server 114 or electronic devices, such as, the traveler device 104 and the aspiring traveler device 108. The system 200 enables a plurality of users (e.g., the traveler 102 and the aspiring traveler 106a to 106n) to create real-time travel journeys.

In an embodiment, the system 200 includes a database 202, a user interface (UI) module 204, a traveler account management module 206, an update management module 208, a travel journey creation module 210, a reward management module 212, an itinerary creation engine 214, a processing module 216 and a centralized circuit system 218.

The database 202 is configured to store a plurality of travel journeys created by a plurality of travelers. Each travel journey stored in the database 202 includes primary and secondary journey details associated with corresponding travel journey. The database 202 may be also configured to store profile data associated with profiles of the plurality of travelers, a plurality of aspiring travelers and one or more individuals. The profile data includes, but are not limited to, name, e-mail id, password and contact information.

The user interface module 204 is in communication with the database 202. The user interface module 204 is configured to present one or more UIs for facilitating creation of real-time travel journeys for seasoned and aspiring travelers. The UI module 204 includes an input interface 204a and an output interface 204b. The input interface 204a is configured to receive primary journey details and secondary journey details associated with a journey performed by a traveler (e.g., the traveler 102). The primary journey details includes name of travel journey, starting date of journey and starting location of journey. The secondary journey details includes one or more of event information, pictures, videos, audios, ratings, travel mode, distance covered, time spent on travel, destination information, date, journey experience, travel type, total expenditure on journey, name of booking platforms used and tags. The input interface 204a is also configured to receive search query asked by an aspiring traveler (e.g., the aspiring traveler 106). Further, the input interface 204a is configured to receive journey requirement input from the aspiring traveler. Additionally, the input interface 204a is configured to receive a request for setting up a meeting or a mentoring session for receiving mentoring services from a traveler of his/her choice. Examples of the input interface 204a may include, but are not limited to, a keyboard, a mouse, a joystick, a keypad, a touch screen, soft keys, a floppy disk, a pen drive, a hard drive and the like. The output interface 204b is configured to display the travel journeys stored in the database 202 to the users of system 200. In an embodiment, the output interface 204b is configured to display search results for the search query asked by the aspiring traveler. In another embodiment, the output interface 204b is configured to display custom itineraries created for the aspiring travelers based on the journey requirement input provided by the aspiring travelers. In yet another embodiment, the output interface 204b is configured to display suggestions and notifications to the aspiring travelers. In further yet another embodiment, the output interface 204b is configured to display profiles of the plurality of travelers, the plurality of aspiring travelers and the one or more individuals. Examples of the output interface 204b may include, but are not limited to, a display such as a light emitting diode (LED) display, a thin-film transistor (TFT) display, a liquid crystal display, an active-matrix organic light-emitting diode (AMOLED) display, and the like.

The traveler account management module 206 is in communication with the UI module 204 and the database 202. The traveler account management module 206 is configured to create profiles of the users (e.g., traveler profiles, aspiring traveler profiles and profiles of one or more individuals) based on the profile data provided by the users. The traveler account management module 206 is also configured to manage the profiles of the users. The management of the profiles include, but are not limited to, management of the type of access set by each user, management of the privacy of each profile, management of travel journeys posted by travelers, management of chats, management of likes on the travel journeys, management of bookmarks on the travel journeys, management of ratings, management of travelers inspired, management of money earned by each user, management of rewards earned by each user and management of display picture and their mode of display.

In an embodiment, the update management module 208 is in communication with the database 202 and the UI module 204. The update management module 208 is configured to manage updates performed on the primary and secondary journey details provided by the travelers. The update management module 208 is also configured to share the updates performed on the primary and secondary journey details associated with each travel journey with the one or more individuals selected by the traveler associated with that particular journey.

The travel journey creation module 210 is in communication with the traveler account management module 206, the UI module 204 and the database 204. The travel journey creation module 210 is configured to create travel journeys for each traveler based on the primary and the secondary journey details provided by each traveler.

The reward management module 212 is in communication with the database 202 and the traveler account management module 206. The reward management module 212 is configured to determine one or more seasoned travelers from the plurality of travelers based on a predefined criteria. The predefined criteria are set by an administrator of the system 200. The reward management module 212 is also configured to reward the one or more seasoned travelers with one or more gifts. The one or more gifts include at least one of badges; reward points; pins; and merchandize.

In an embodiment, the itinerary creation engine 214 is in communication with the database 202 and the UI module 206 for creating custom itineraries for the aspiring travelers. The itinerary creation engine 214 is configured to access one or more travel journeys relevant for each aspiring traveler from the database 202 based in part on the journey requirement input provided by the each aspiring traveler. For example, the aspiring traveler wants to travel to England with two infants so the journey requirement input provided by the aspiring traveler may be something like ‘England trip with two infants’. In that case, the itinerary creation engine 214 may look for the travel journeys where the traveler has mentioned about travel to England with one or more infants or any similar country with one or more infants. The itinerary creation engine 214 is also configured to create custom itinerary for each aspiring traveler based, in part, on the journey requirement input provided by each aspiring traveler and the one or more travel journeys accessed based on the journey requirement input using machine learning and artificial intelligence techniques. The custom itinerary created by the itinerary creation engine 214 may include information of the booking sites in a most optimal combination in terms of travel budget and duration to help the aspiring traveler so that the aspiring traveler can book a complete travel in one go.

The processing module 216 is configured to coordinate with the database 202, the UI module 204, the traveler account management module 206, the update management module 208, the travel journey creation module 210, the reward management module 212 and the itinerary creation engine 214 of the system 200 for operation of the various components of the system 200.

The database 202, the UI module 204, the traveler account management module 206, the update management module 208, the travel journey creation module 210, the reward management module 212, the itinerary creation engine 214 and the processing module 216 may be configured to communicate with each other via or through the centralized circuit system 218. The centralized circuit system 218 may be various devices configured to, among other things, provide or enable communication between the modules (202-216) of the system 200. In certain embodiments, the centralized circuit system 218 may be a central printed circuit board (PCB) such as a motherboard, a main board, a system board, or a logic board. The centralized circuit system 218 may also, or alternatively, include other printed circuit assemblies (PCAs) or communication channel media. In some embodiments, the centralized circuit system 218 may include appropriate storage interfaces to facilitate communication among the modules (202-216). Some examples of the storage interface may include, for example, an Advanced Technology Attachment (ATA) adapter, a Serial ATA (SATA) adapter, a Small Computer System Interface (SCSI) adapter, a RAID controller, a SAN adapter or a network adapter.

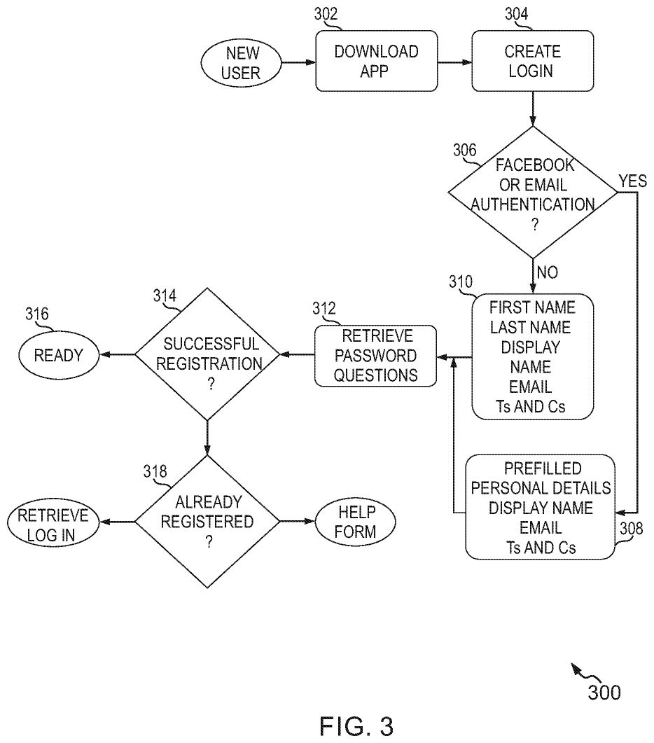

FIG. 3 is a flow diagram 300 for performing registration of a new user, in accordance with an example embodiment. In an embodiment, the new user is a traveler (e.g., the traveler 102). In another embodiment, the new user is an aspiring traveler (e.g., the aspiring traveler 106). In yet another embodiment, the new user is an individual (e.g., one from the group of individuals 110). The operations of the flow diagram 300 may be carried out by a server such as the server 114, the system 200 or the electronic devices 104 and 108. The sequence of operations of the flow diagram 300 may not to be necessarily executed in the same order as they are presented. Further, one or more operations may be grouped together and performed in form of a single step, or one operation may have several sub-steps that may be performed in parallel or in sequential manner.

At operation 302, the new user downloads the social journaling platform 116. At operation 304, once the download is complete, the new user creates login on the social journaling platform 116. At operation 306, the login is authenticated with Facebook® or e-mail accounts. If the new user is successfully authenticated using the Facebook or e-mail accounts, operation 308 is performed else operation 310 is performed. At operation 308, prefilled personal details such as display name and e-mail id is displayed to the new user along with terms and conditions that the new user needs to accept for registering with the social journaling platform 116.

At operation 310, as the new user is failed to authenticate himself, the new user has been asked to provide a plurality of details, such as first name, last name, display name, and e-mail id. The new user has to accept the terms and conditions of the social journaling platform 116 for completing successful registration. At operation 312, as the user details are available with the social journaling platform 116, predefined password questions are retrieved and displayed to the new user. The new user has to select one or two password questions and has to provide answers for the selected password questions. The provided answers along with the selected password questions are stored in the created profile of the new user. Once the answers are provided by the new user, the registration process completes.

At operation 314, it is checked whether new user registration is successful. If the new user registration found to be successful, operation 316 is performed else operation 318 is performed. At operation 316, the new user profile is ready and can be used by the new user for performing various activities on the social journaling platform 116. At operation 318, it is checked whether the new user is already a registered user of the social journaling platform 116. If the new user found to be the registered user, steps for retrieving login credentials are displayed otherwise the new user is directed to a help form which will help the user in completing registration process.

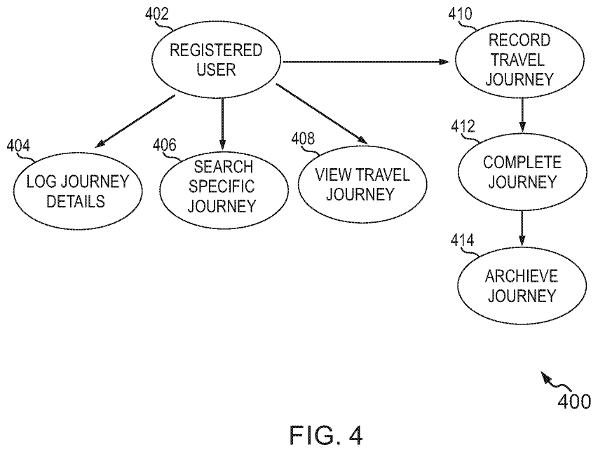

FIG. 4 is a schematic representation 400 illustrating preferences of a registered user 402. In an embodiment, the registered user 402 can be a traveler (e.g., the traveler 102). In another embodiment, the registered user 402 can be an aspiring traveler (e.g., the aspiring traveler 106). In yet another embodiment, the registered user 402 can be an individual.

As shown in FIG. 4, the registered user 402 can log his/her journey details 404 for creating travel journey. Specifically, the registered user 402 can search for specific journeys 406, can view travel journeys 408 and/or can record travel journeys 410 based on his/her preference. When the registered user 402 completes the recording of the travel journey 410, the travel journey is completed 412 and archived 414 for future use.

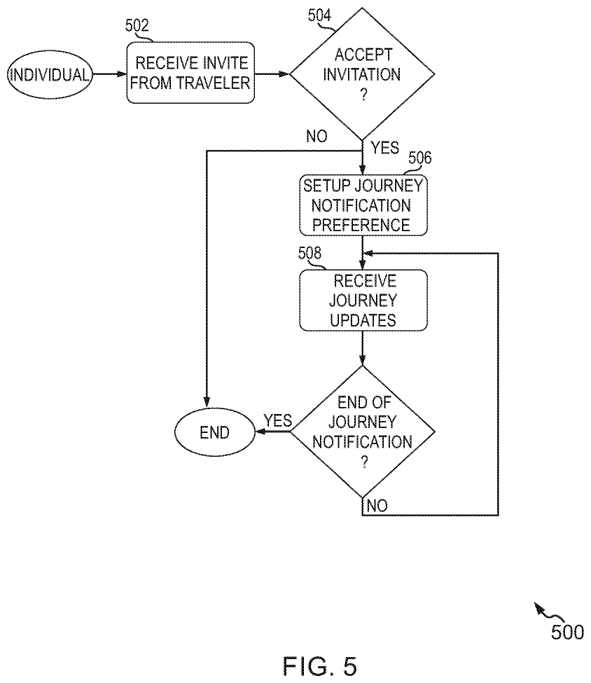

FIG. 5 is a flow diagram 500 for setting preferences for a travel journey shared by a traveler to an individual, in accordance with an example embodiment. The traveler may send an invitation to the individual for viewing the travel journey posted by the traveler. In current example, the individual is a registered user of the social journaling platform 116.

At operation 502, the individual receives an invitation sent by the traveler for viewing the travel journey posted by the traveler. In an embodiment, the invitation may be sent in form of a message using contact information of the individual. In another embodiment, the invitation may be sent in form of an e-mail using email id of the individual. In yet another embodiment, the invitation may be sent in form of a notification on the social journaling platform 116 installed on an individual device. At operation 504, the individual may or may not accept the invitation. If the individual accepts the invitation, operation 506 is performed.

At operation 506, the individual is asked to setup journey notification preference i.e. the individual has to decide whether he/she wants to receive notifications for the updates performed on the travel journey posted by the traveler. The individual can choose to receive and can decline also.

At operation 508, if the individual chooses to receive the updates, the individual keeps on receiving journey updates from the traveler until the end of the journey. In an embodiment, the journey updates are sent in form of notifications on the social journaling platform 116.

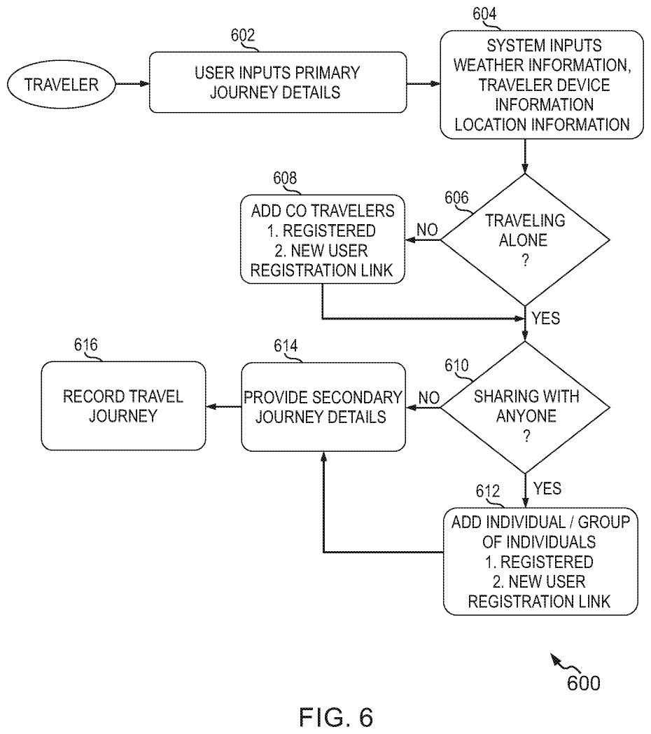

FIG. 6 is a flow diagram 600 for recording travel journey, in accordance with an example embodiment. The travel journey can be recorded by a traveler (e.g., the traveler 102) who has traveled to or traveling to some location and wants to record everything he/she has done or doing during a trip. The operations of the flow diagram 600 may be carried out by a server such as the server 114, the system 200 or the traveler device 104. The sequence of operations of the flow diagram 600 may not to be necessarily executed in the same order as they are presented. Further, one or more operations may be grouped together and performed in form of a single step, or one operation may have several sub-steps that may be performed in parallel or in sequential manner.

At operation 602, the traveler provides primary journey details to start creation of a travel journey. The primary journey details includes name of travel journey, starting date of journey and starting location of journey. At operation 604, weather information, traveler device information and location information are inserted by the system 200. The weather information includes, but is not limited to, temperature, precipitation, humidity and wind speed of the starting location. The traveler device information includes traveler device name and model number of the traveler device.

At operation 606, the traveler has to define whether the traveler is traveling alone or in a group. If the traveler is traveling alone, operation 610 is performed else operation 608 is performed. At operation 608, the traveler is asked to add co-travelers in the travel journey. The co-travelers can already be registered users of system 200. In case of new users, a new user registration link is sent by the system 200 to each co-traveler. The co-travelers can use the new user registration link to directly register with the system 200.

At operation 610, the traveler has to decide whether he/she wants to share the travel journey with anyone. If the traveler wishes to share the travel journey, operation 612 is performed else operation 614 is performed. At operation 612, the traveler is asked to add an individual or a group of individuals with whom the traveler wants to share the travel journey. The individual or group of individuals can already be registered users of system 200. In case of new users, a new user registration link is sent by the system 200 to each individual in case of group of individuals. The individual or the group of individuals can use the new user registration link to directly register with the system 200 to view the travel journey of the traveler.

At operation 614, the traveler has to provide secondary journey details associated with the journey to complete the travel journey. The secondary journey details includes one or more of event information, pictures, videos, audios, ratings, travel mode, distance covered, time spent on travel, destination information, date, journey experience, travel type, name of booking platforms used, total expenditure on journey and tags. At operation 616, the travel journey including the primary journey details and the secondary journey details is recorded in the system 200.

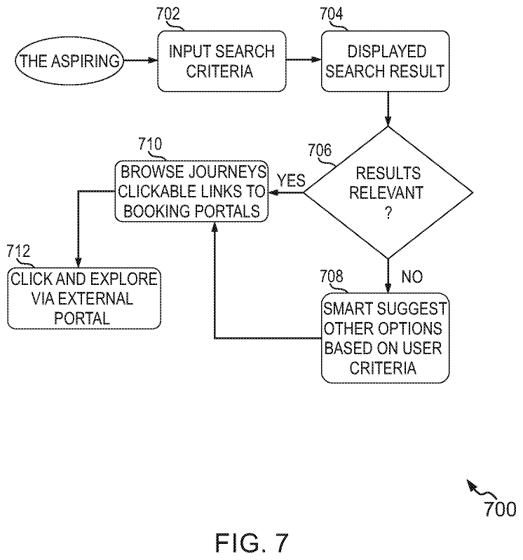

FIG. 7 is a flow diagram 700 for searching travel journeys, in accordance with an example embodiment. The travel journeys can be searched by an aspiring traveler (e.g., the aspiring traveler 106) who wants to plan a travel to some location. The operations of the flow diagram 700 may be carried out by a server such as the server 114, the system 200 or the aspiring traveler device 108. The sequence of operations of the flow diagram 700 may not to be necessarily executed in the same order as they are presented. Further, one or more operations may be grouped together and performed in form of a single step, or one operation may have several sub-steps that may be performed in parallel or in sequential manner.

At operation 702, the aspiring traveler inputs/provides search criteria for the travel journeys. In an embodiment, the search criteria are provided in form of search strings. In another embodiment, the search criteria are provided in form of keywords. At operation 704, the search results are displayed to the traveler.

At operation 706, the system 200 checks whether the search results are relevant results or not. If the search results are found to be relevant, operation 710 is performed directly else first operation 708 is performed, and then operation 710 is performed. At operation 708, the system 200 suggests few other options similar to the search criteria provided by the aspiring traveler.

At operation 710, the aspiring traveler is allowed to browse the travel journeys and can also click on links provided on the travel journeys that would direct them to booking portals used by the traveler who posted the travel journey. At operation 712, the aspiring traveler is allowed to click and explore via external booking portal. In an embodiment, the external booking portal may pay some pre-decided amount per view to the system 200.

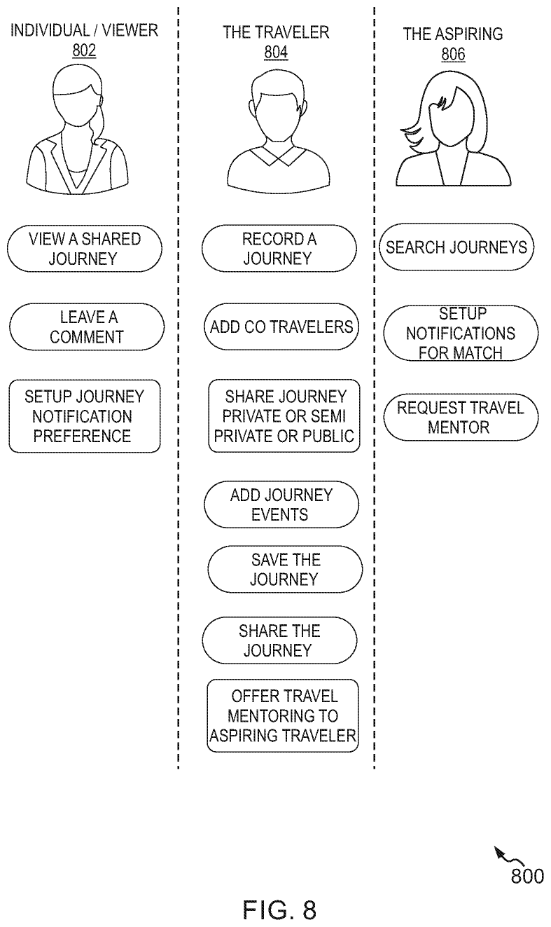

FIG. 8 is a schematic diagram 800 depicting role of each user of the social journaling platform 116, in accordance with an example embodiment. The social journaling platform 116 includes three categories of users namely, individuals/viewers 802, travelers 804 and aspiring travelers 806. The role of each category of user is explained with reference to FIG. 8.

As shown in FIG. 8, the individuals/viewers 802 are allowed to view travel journeys shared by the traveler, leave one or more comments on the travel journeys and can set journey notification preference for the updates done on the travel journeys. Similarly, the travelers 804 can record travel journeys, add co-travelers, share journeys with others in different access modes, add events attended during the journeys, save journeys, share journeys and can also offer travel mentoring services to aspiring travelers.

In an embodiment, the aspiring travelers 806 can search for journeys, setup notifications for match, ask for custom itinerary by providing journey requirement input and can also receive travel mentoring services from seasoned travelers by paying some amount to the social journaling platform 116.

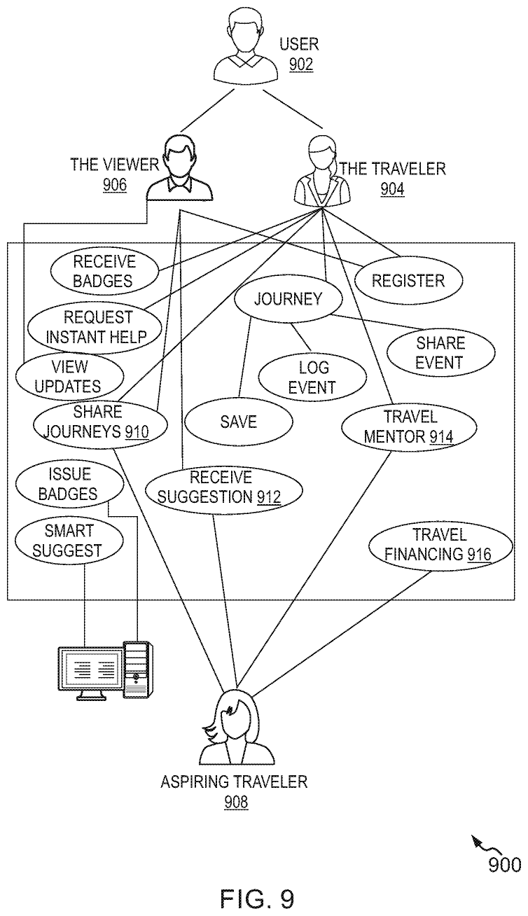

FIG. 9 is a schematic representation of a use case diagram 900 of high-level functions performed by users of the social journaling platform 116 resting at the server 114, in accordance with an example embodiment. The use case diagram 900 lists all the high-level functions performed by the three categories of users of the social journaling platform 116 as discussed in FIG. 8.

As shown in FIG. 9, a user 902 can act as traveler 904 when the user 902 wants to add travel journeys and the user 902 can also act as a viewer 906 when the user 902 is invited by some other traveler to view the travel journey posted by the other traveler. An aspiring traveler 908 may or may not be a registered user of the social journaling platform 116.

The use case diagram 900 includes a plurality of ellipses for representing a plurality of use cases and a plurality of connecting lines for connecting the plurality of use cases with the users. In an embodiment, a use case represents a set of action that can be performed by a user, such as the user 902.

The aspiring traveler 908 is shown to be connected with four use cases i.e. a share journey use case 910, a receive suggestion use case 912, a travel mentor use case 914 and a travel financing use case 916 which means the aspiring traveler 908 can share travel journeys, can receive suggestions from travelers, can receive travel mentoring services from travelers and can also receive travel financing tips from the travelers.

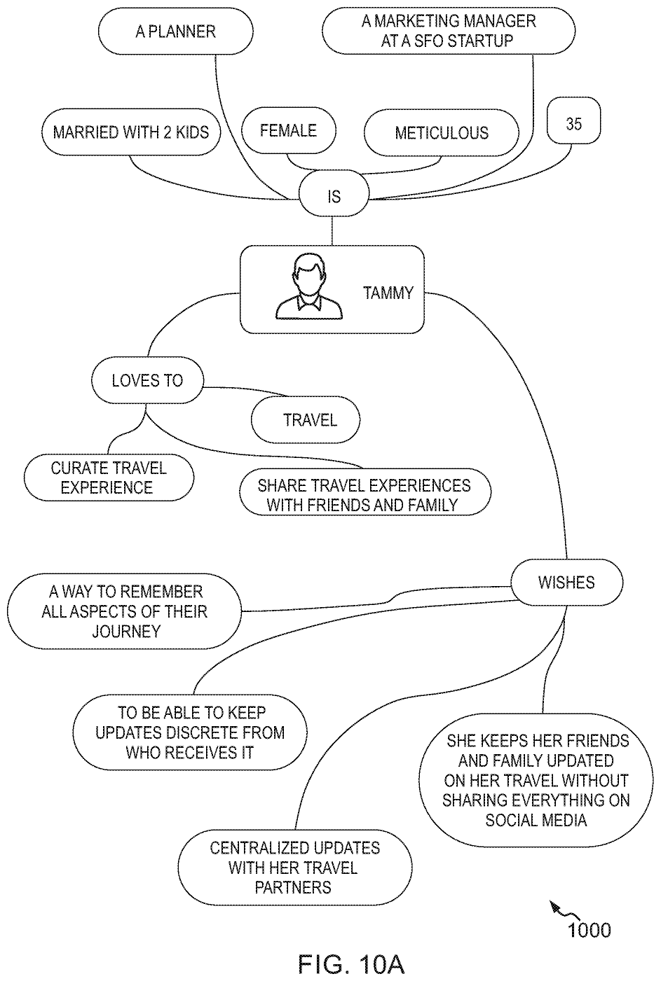

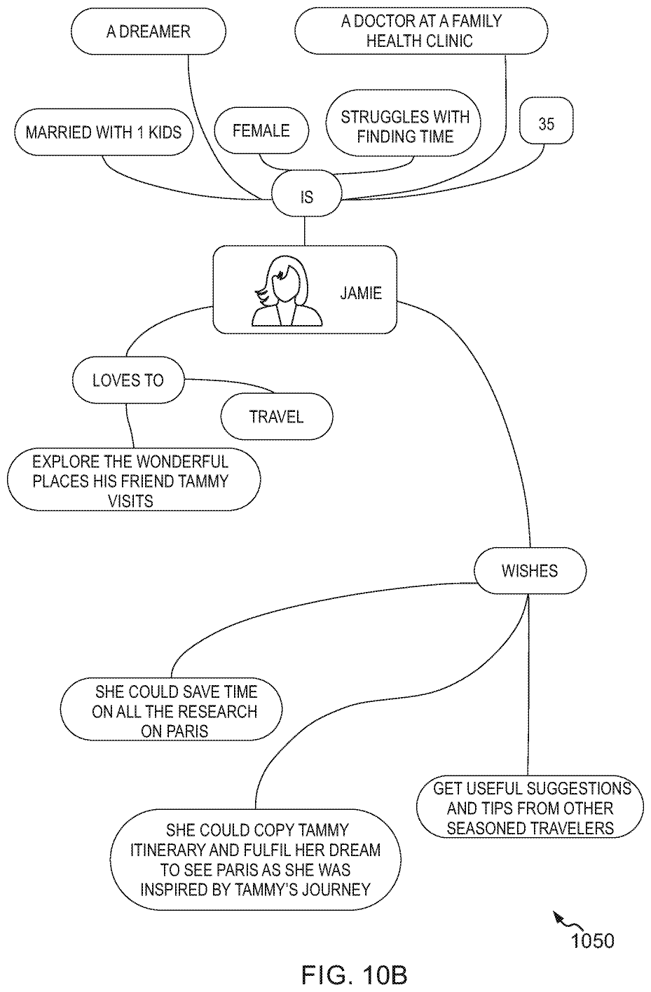

FIG. 10A is a schematic representation 1000 of a persona of a seasoned traveler, in accordance with an example embodiment. The representation 1000 depicts information related to the persona of the seasoned traveler. The information includes personal information such as gender, age, occupation, family information, information about what the persona loves to do and information about wishes of persona.

As shown in FIG. 10A, the traveler persona ‘TAMMY’ is a female of 35 years, is married with 2 kids, is a marketing manager at a SFO start-up, is a planner and is meticulous.

FIG. 10B is a schematic representation 1050 of a persona of an aspiring traveler, in accordance with an example embodiment. The representation 1050 depicts information related to the persona of the aspiring traveler. The information includes personal information such as gender, age, occupation, family information, information about what the persona loves to do and information about wishes of persona.

As shown in FIG. 10B, the aspiring traveler persona ‘JAMIE’ is a female of 35 years, is married with 1 kid, is a doctor at a family clinic, is a dreamer and is struggling with finding time.

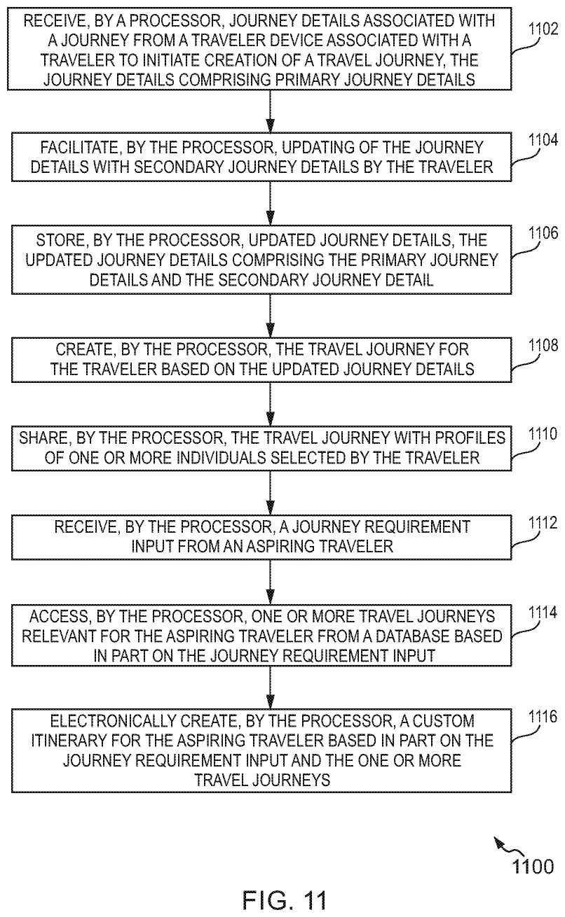

FIG. 11 is a flowchart illustrating a method 1100 for real-time travel journey creation for aspiring and seasoned traveler, in accordance with an example embodiment. The operations of the method 1100 may be carried out by a server such as the server 114, the system 200 or the electronic devices 104 and 108a to 108n. The sequence of operations of the method 1100 may not be necessarily executed in the same order as they are presented. Further, one or more operations may be grouped together and performed in form of a single step, or one operation may have several sub-steps that may be performed in parallel or in sequential manner.

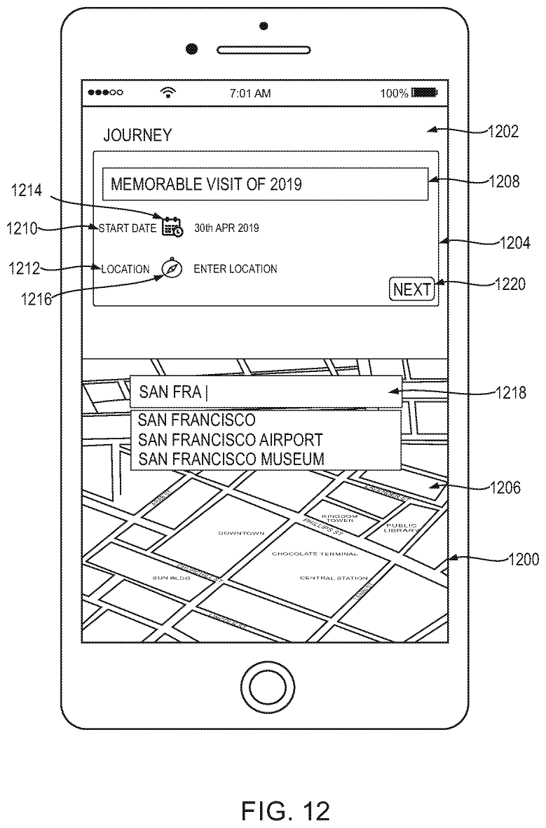

At operation 1102, the method 1100 includes receiving, by a processor, journey details associated with a journey from a traveler device associated with a traveler to initiate creation of a travel journey. The journey details include primary journey details. The traveler who wishes to curate and share his/her journey experience provides the primary journey details, such as name of travel journey, starting date of journey and starting location of journey using the traveler device to initiate the creation of the travel journey. The name of travel journey gives a brief description about the travel journey and may be displayed to represent that particular journey. For example, if a traveler has traveled to Spain in year 2019, then the traveler can name the journey as ‘2019 trip of Spain’. So, whoever sees the travel journey posted by the traveler may get an idea that travel journey is about Spain in 2019. A user interface (UI) for receiving primary journey details is discussed in detail with reference to FIG. 12.

At operation 1104, the method 1100 includes facilitating, by the processor, updating of the journey details with secondary journey details by the traveler. As the travel journey creation is initiated, the traveler needs to provide secondary journey details to complete the travel journey as the primary journey details provide just the basic introduction of the travel journey. The secondary journey details includes one or more of information about events that the traveler has attended during the journey, pictures taken during the journey, videos, audios, ratings of places visited during the journey, travel mode (by plane, ship, train, bus, car or walk), distance covered, time spent on travel, destination information, dates, journey experience, travel type (solo or group), total expenditure on journey, name of booking platforms used and tags which are related to the journey. The secondary journey details along with the primary journey details may help an aspiring traveler in planning their journey.

At operation 1106, the method 1100 includes storing, by the processor, updated journey details. The updated journey details include the primary journey details and the secondary journey details. The updated journey details are stored in a database under the name of the journey. The updated journey details can also be shared with profiles of one or more individuals who are selected by the traveler while maintaining privacy of each profile/individual.

At operation 1108, the method 1100 includes creating, by the processor, the travel journey for the traveler based on the updated journey details. The updated journey details are used to create the travel journey for the traveler. The created travel journey is stored in the database and can be displayed to one or more aspiring travelers who are interested in knowing about the travel experience of the traveler. The traveler can also send invites to the profile of the one or more individuals who are interested in viewing the travel journey.

At operation 1110, the method 1100 includes sharing, by the processor, the travel journey with profiles of one or more individuals selected by the traveler. The travel journey created for the traveler is shared with the one or more individuals who are selected by the traveler. The one or more individuals may or may not be registered users of the social journaling platform 116. In case of non-registered individuals, first a link to create a profile with the social journaling platform 116 is sent to the one or more individuals, then after creation of the profiles using the link, the travel journey is displayed to the one or more individuals.

At operation 1112, the method 1100 includes receiving, by the processor, a journey requirement input from an aspiring traveler. The aspiring traveler who wishes to travel to a location and requires a prepared custom itinerary may provide the journey requirement input. The journey requirement input includes requirements that need to be fulfilled by the custom itinerary. For example, the aspiring traveler may want to travel to Israel on low budget and with a pet. So, the journey requirement input can be something like ‘Trip to Israel with a pet on low budget’.

At operation 1114, the method 1100 includes accessing, by the processor, one or more travel journeys relevant for the aspiring traveler from a database based in part on the journey requirement input. The travel journeys that are matching with the journey requirement input provided by the aspiring traveler are accessed from the database. In an embodiment, the performed matching may be keyword based matching. For example, travel journeys which contain description of both pet and Israel are considered. In case of no matching results, individual journeys containing description of pet and Israel are considered.

At operation 1116, the method 1100 includes electronically creating, by the processor, the custom itinerary for the aspiring traveler based in part on the journey requirement input and the one or more travel journeys. The custom itinerary is created for the aspiring traveler based on the requirement placed by the aspiring traveler through the journey requirement input and the one or more travel journeys that are considered at the operation 1114.

FIG. 12 is an example representation of a user interface (UI) 1200 depicting a travel journey creation page 1202 displayed to a user, such as the traveler 102 of the social journaling platform 116, in accordance with an exemplary embodiment of the present disclosure. The UI 1200 is presented on a user device, such as the traveler device 104 shown in FIG. 1. The travel journey creation page 1202 is used to receive primary journey details from the user.

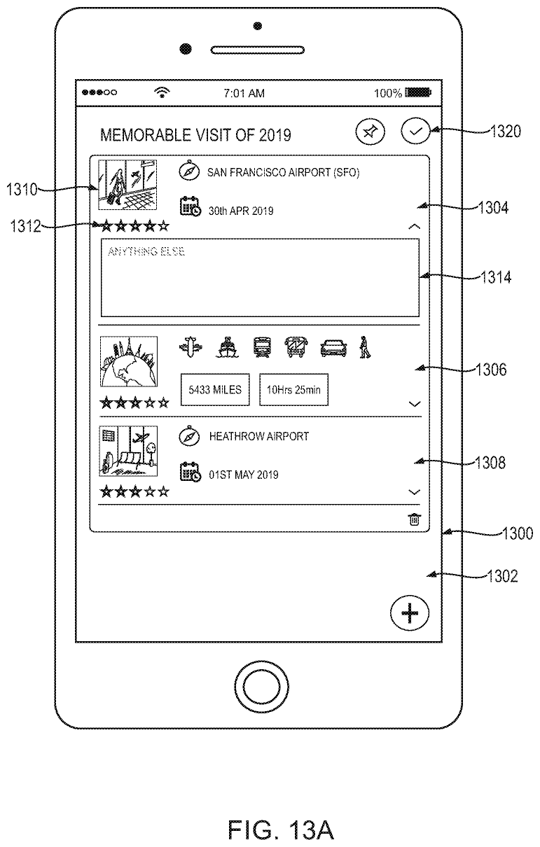

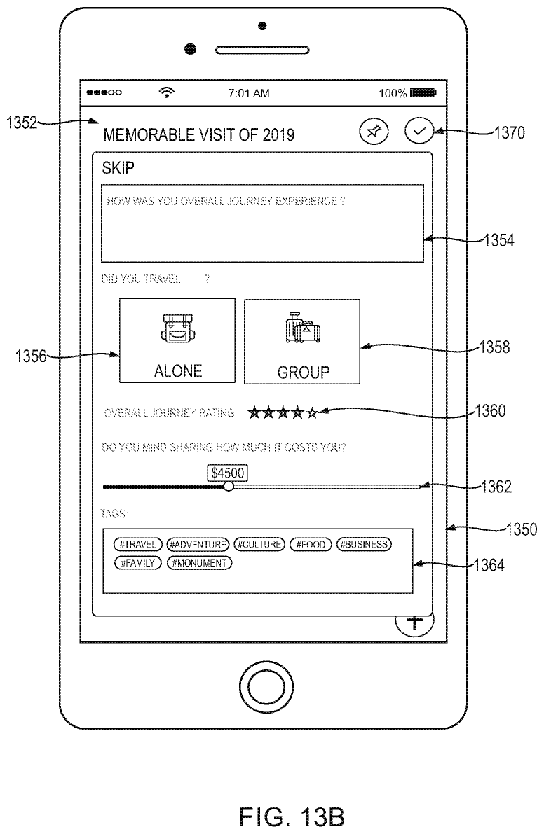

The travel journey creation page 1202 includes a journey detail section 1204 and a map section 1206. The journey detail section 1204 includes a text box 1208 for receiving name of the journey, a start date box 1210 for receiving starting date of the journey, a location box 1212 for receiving starting location of the journey and a next tab 1220. The start date box 1210 includes a date icon 1214. Clicking on the date icon 1214 will display a calendar that can be used by the user for selecting the starting date. Further, the location box 1212 includes a location icon 1216. Clicking on the location icon 1216 will take the cursor to a text box 1218 in the map section 1206. The user can enter the starting location on the text box 1218. The user can also select the starting location on a map displayed in the map section 1206. Clicking on the next tab 1220 will take the user to a secondary detail page 1302. The secondary detail page 1302 is discussed in detail with reference to FIG. 13A.

FIG. 13A is an example representation of a user interface (UI) 1300 depicting the secondary detail page 1302 displayed to a user, such as the traveler 102 by the social journaling platform 116, in accordance with an exemplary embodiment of the present disclosure. The UI 1300 is presented on a user device, such as the traveler device 104 shown in FIG. 1. The secondary detail page 1302 is used to receive secondary journey details from the traveler.

The secondary detail page 1302 includes a primary journey detail section 1304, a travel detail section 1306 and a destination detail section 1308. The primary journey detail section 1304 includes prefilled primary journey details along with a photo box 1310 where the user can add photo associated with starting location, a rating section 1312 comprising a rating scale of 5 (shown by five stars) for providing rating to the starting location and a text box 1314 for receiving description about the starting location. The travel detail section 1306 includes a photo box similar to the photo box 1310 where the user can add photo associated with travel, a rating section similar to the rating section 1312 for providing rating based on experience of travel and 6 travel mode icons. The 6 travel mode icons include a flight icon, a ship icon, a train icon, a bus icon, a car icon and a walking icon. The user can select one travel mode from the 6 travel mode icons to inform about the travel mode that the user has used for traveling. The destination detail section 1308 includes a location icon similar to the location icon 1216, a date icon similar to the date icon 1214, a photo box similar to the photo box 1310 and a rating section similar to the rating section 1312. The user can click on the location icon for selecting destination location and the date icon for selecting date on which the user reached the destination location. The photo box can be used by the user to select a photo related to the destination that the user wants to display. The user can also provide rating to the destination using the rating section. A save icon 1320 is displayed on a top of the secondary detail page 1302. Clicking on the save icon 1320 will direct the user to a more information page 1352. The more information page 1352 is discussed in detail with reference to FIG. 13B.

FIG. 13B is an example representation of a user interface (UI) 1350 depicting the more information page 1352 displayed to a user, such as the traveler 102 of the social journaling platform 116, in accordance with an exemplary embodiment of the present disclosure. The UI 1350 is presented on a user device, such as the traveler device 104 shown in FIG. 1. The more information page 1352 is used to receive more information about the journey from the user. It should be noted that the more information is part of the secondary journey details.

The more information page 1352 includes a text box 1354 for receiving information about overall journey experience of the user, two travel type icons 1356 and 1358 under the name of ‘Alone’ and ‘Group’, respectively, an overall rating section 1360 comprising a rating scale of 5 (shown by five stars) for receiving rating for the travel based on overall journey experience, a total expenditure bar 1362 for receiving total expenditure on journey and a tags segment 1364 for selecting tags which defines the trip. The user can select icon 1356 if the user was traveling alone and the icon 1358 is the user was traveling in a group. A save icon 1370 is displayed on a top of the more information page 1352. Clicking on the save icon 1370 will create the travel journey for the user and a journey creation popup (not shown in figures) may be displayed to the user for informing user about the creation of the travel journey.

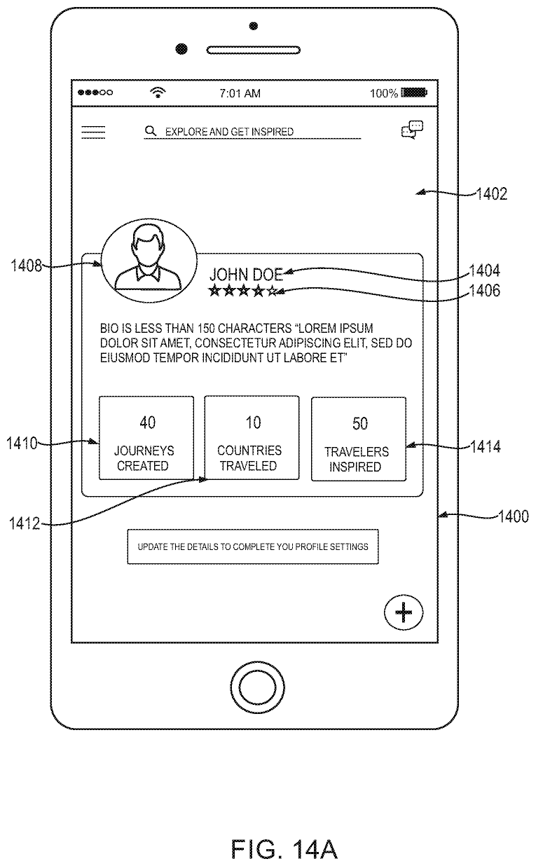

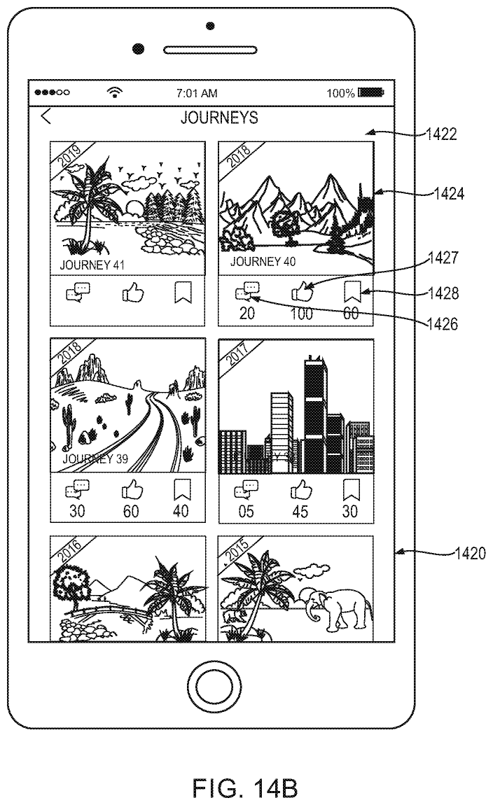

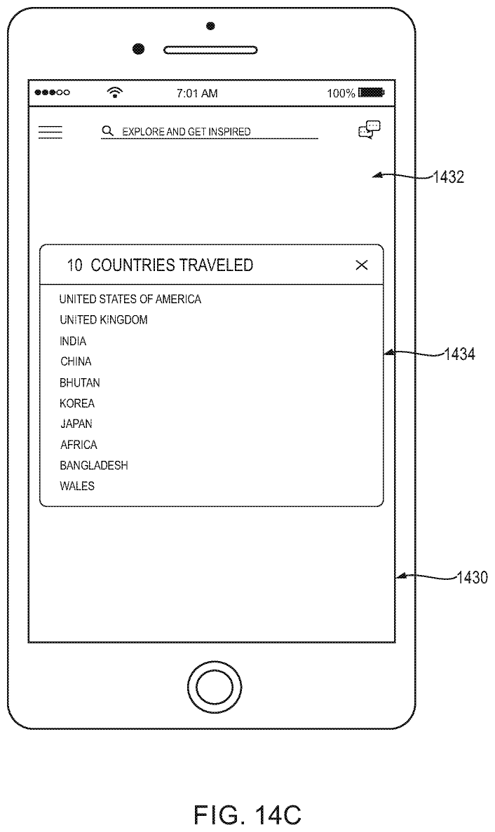

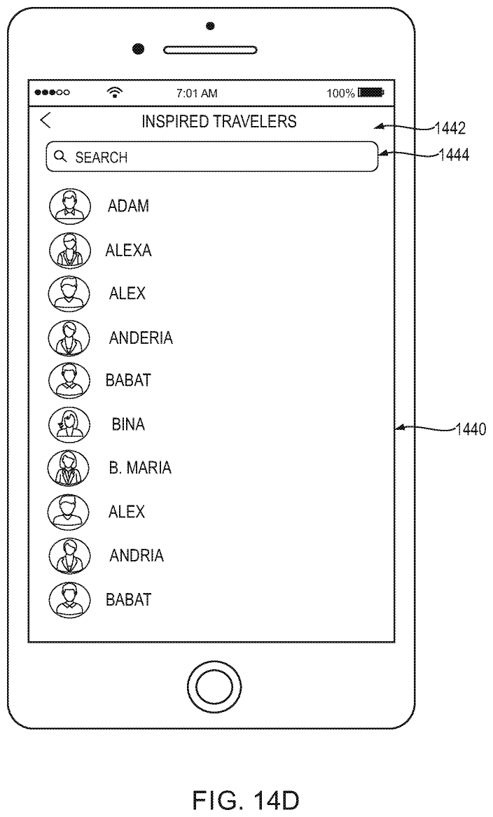

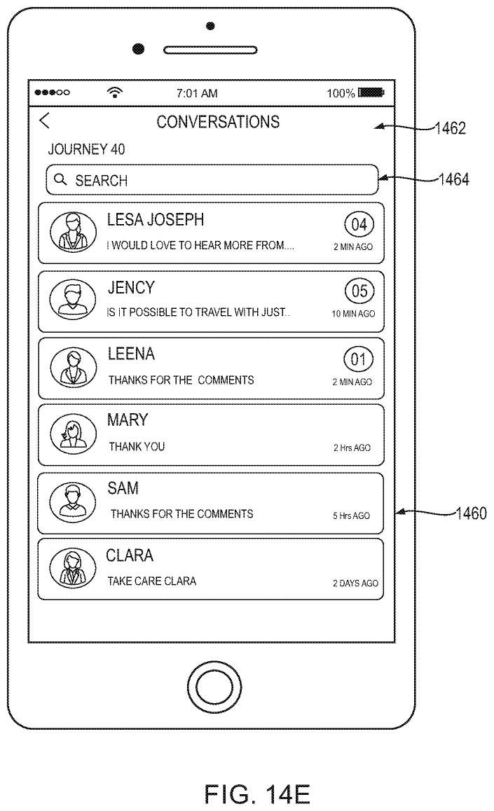

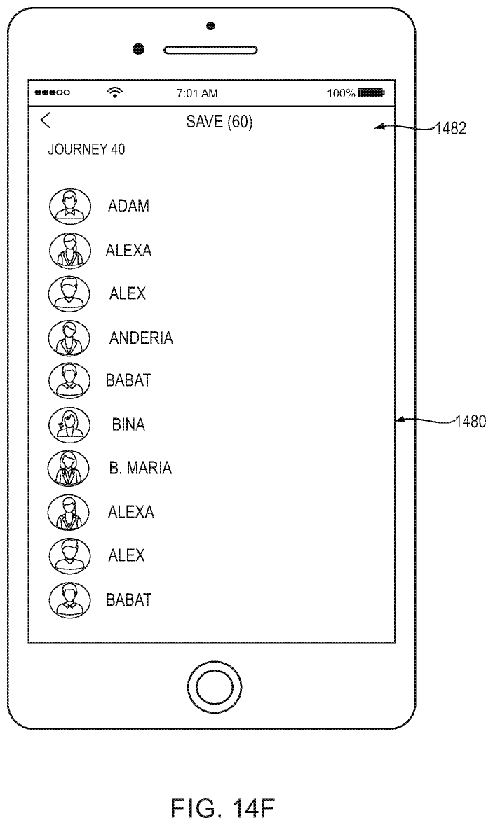

FIG. 14A is an example representation of a user interface (UI) 1400 depicting a traveler profile page 1402 displayed to the users, such as the traveler 102 and the aspiring traveler 106 by the social journaling platform 116, in accordance with an exemplary embodiment of the present disclosure. The UI 1400 is presented on user devices, such as the traveler device 104 and the aspiring traveler devices 108a to 108n as shown in FIG. 1. The traveler profile page 1400 displays information about a traveler (e.g., the traveler 102) who has posted at least one travel journey.

The traveler profile page 1402 includes a traveler name 1404, a traveler rating section 1406 displaying average rating of the traveler on a rating scale of 5 (shown by five stars), a little bio about the traveler, a profile picture icon 1408 displaying a profile picture set by the traveler, a journeys created tab 1410 displaying number of travel journeys posted by the traveler, a countries traveled tab 1412 displaying number of countries traveled by the traveler and a travelers inspired tab 1414 displaying number of aspiring travelers inspired by the traveler. The rating section 1406 displays the average rating of all the travel journeys rated by aspiring travelers. Clicking on the journeys created tab 1410 will redirect the user to a journeys page 1422 which is discussed in detail with reference to FIG. 14B. Clicking on the countries traveled tab 1412 will redirect the user to a countries traveled page 1432 which is discussed in detail with reference to FIG. 14C. Clicking on the travelers inspired tab 1414 will redirect the user to a traveler inspired page 1442 which is discussed in detail with reference to FIG. 14D.

FIG. 14B is an example representation of a user interface (UI) 1420 depicting the journeys page 1422 displayed to the users, such as the traveler 102 and the aspiring traveler 106 by the social journaling platform 116, in accordance with an exemplary embodiment of the present disclosure. The UI 1420 is presented on user devices, such as the traveler device 104 and the aspiring traveler devices 108a to 108n as shown in FIG. 1. The journeys page 1422 displays all the travel journeys that are posted by the traveler as discussed in FIG. 4A.

The journeys page 1422 includes a journey segment corresponding to each journey that is posted by the traveler. The journey segment includes a random picture from that travel journey, a journey number, year in which the journey was done, a chat icon displaying number of chats received from the users for that travel journey, a like icon displaying number of likes received for that travel journey and a bookmark icon displaying a number of times the users have saved that travel journey. It should be noted that chat icon will not be displayed to the user if the user is anyone else except the traveler whose posted travel journeys are being displayed on the journeys page 1422. For example, the journey segment 1424 is 40^{th} journey posted by the traveler which is done in year 2018. The journey segment 1424 also includes a chat icon 1426 displaying number ‘20’ which means 20 chats are received from the users for the travel journey 40, a like icon 1427 displaying number ‘100’ which means 100 likes are received for the travel journey 40 and a bookmark icon 1428 displaying a number ‘60’ which means 60 times the users have saved the travel journey 40. Clicking on the journey segment 1424 will redirect the user to a journey detail page (not shown in figures). Clicking on the chat icon 1426 will redirect the user to a conversation page 1462 which is discussed in details with reference to FIG. 14E. Clicking on the bookmark icon 1428 will redirect the user to a save page 1482 which is discussed in details with reference to FIG. 14F.

FIG. 14C is an example representation of a user interface (UI) 1430 depicting the countries traveled page 1432 displayed to the users, such as the traveler 102 and the aspiring traveler 106 by the social journaling platform 116, in accordance with an exemplary embodiment of the present disclosure. The UI 1420 is presented on user devices, such as the traveler device 104 and the aspiring traveler devices 108a to 108n as shown in FIG. 1. The countries traveled page 1432 displays a list 1434 including name of countries that are visited by traveler as discussed in FIG. 4A.

FIG. 14D is an example representation of a user interface (UI) 1440 depicting the traveler inspired page 1442 displayed to the users, such as the traveler 102 and the aspiring traveler 106 by the social journaling platform 116, in accordance with an exemplary embodiment of the present disclosure. The UI 1440 is presented on user devices, such as the traveler device 104 and the aspiring traveler devices 108a to 108n as shown in FIG. 1. The traveler inspired page 1442 displays name of the travelers that are inspired by the traveler as discussed in FIG. 4A.

The traveler inspired page 1442 includes a search box 1444 providing search functionality for searching an inspired traveler from a list of inspired traveler, and the list of the inspired traveler including all unique inspired travelers who have saved the journeys posted by the traveler. The list of inspired traveler includes a name of the each inspired traveler along with their profile picture.

FIG. 14E is an example representation of a user interface (UI) 1460 depicting the conversation page 1462 displayed to a user, such as the traveler 102 by the social journaling platform 116, in accordance with an exemplary embodiment of the present disclosure. The UI 1460 is presented on user device, such as the traveler device 104 as shown in FIG. 1. The conversation page 1462 displays a list of conversation that are received for the travel journey posted in journey segment 1424 as discussed in FIG. 4B.

The conversation page 1462 includes a search box 1464 providing search functionality for searching for a conversation from a particular aspiring traveler, and the list of conversation that are received from a plurality of aspiring traveler. Each conversation in the list of conversation includes a name of aspiring traveler, a profile picture and last message sent by the aspiring traveler. Conversations may also display number of unread chats in case unread chats are there.

FIG. 14F is an example representation of a user interface (UI) 1480 depicting the save page 1482 displayed to the users, such as the traveler 102 and the aspiring traveler 106a to 106n by the social journaling platform 116, in accordance with an exemplary embodiment of the present disclosure. The UI 1480 is presented on user devices, such as the traveler device 104 and the aspiring traveler device 108a to 108n as shown in FIG. 1. The save page 1482 includes a list of aspiring travelers who have saved the travel journey posted in journey segment 1424 as discussed in FIG. 14B.

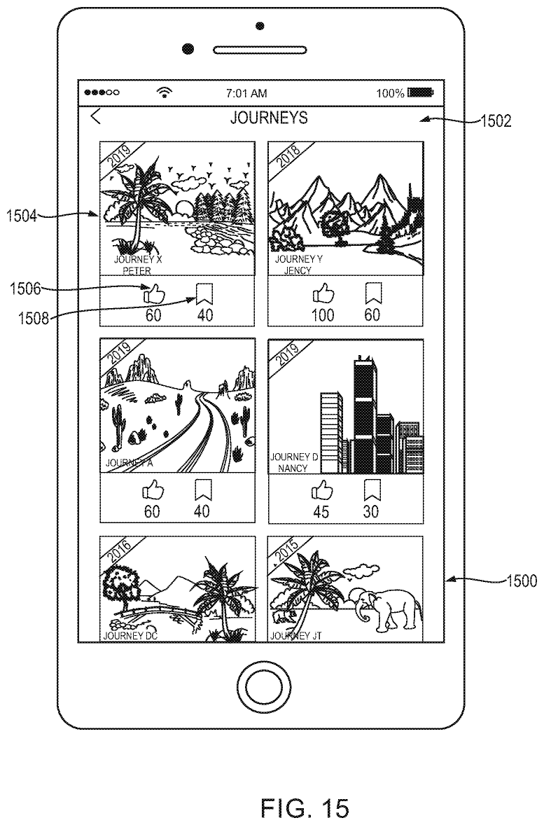

FIG. 15 is an example representation of a user interface (UI) 1500 depicting a journey page 1502 displayed to users, such as the aspiring travelers 106a to 106n by the social journaling platform 116, in accordance with an exemplary embodiment of the present disclosure. The UI 1500 is presented on user devices, such as the aspiring traveler devices 108a to 108n as shown in FIG. 1. The journey page 1502 displays travel journeys that are relevant as per a search performed by an aspiring traveler (e.g., the aspiring traveler 106).

The journey page 1502 includes a journey segment corresponding to each journey that is found to be relevant with search criteria inputted by the aspiring traveler. The journey segment includes a random picture from that travel journey, a journey number along with a traveler name who has posted that journey, year in which the journey was done, a like icon displaying number of likes received for that travel journey and a bookmark icon displaying a number of times the users have saved that travel journey. For example, a journey segment 1504 includes a journey ‘x’ posted by the traveler ‘Peter’ which is done in year 2019. The journey segment 1504 also includes a like icon 1506 displaying number ‘60’ which means 60 likes are received for the travel journey x and a bookmark icon 1508 displaying a number ‘40’ which means 40 times the users have saved the travel journey x. Clicking on the journey segment 1504 will redirect the user to a journey detail page (not shown in figures). Clicking on the bookmark icon 1508 will redirect the user to a save page similar to the save page 1482 discussed with reference to FIG. 14F.

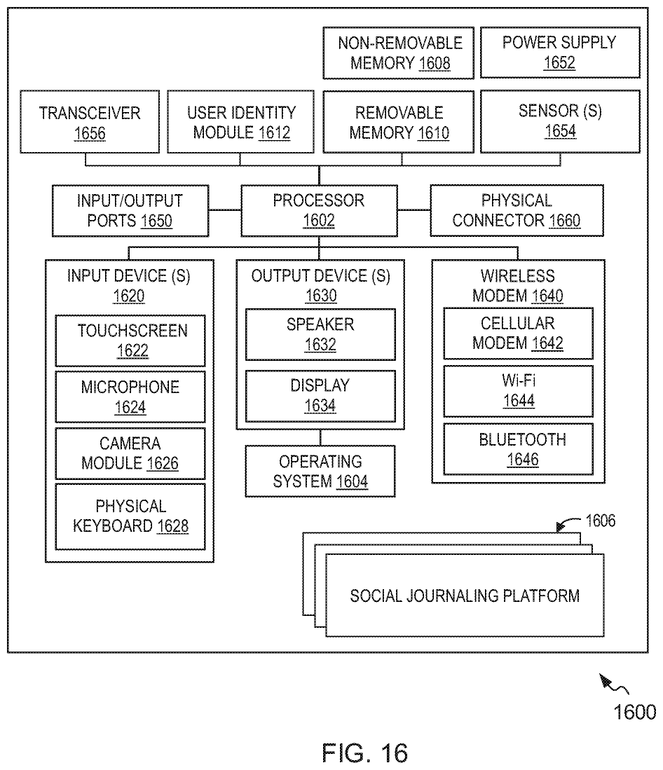

FIG. 16 shows a simplified block diagram of an electronic device 1600 capable of implementing the various embodiments of the present disclosure. The electronic device 1600 may be an example of the electronic devices 104 and 108. It should be understood that the electronic device 1600 as illustrated and hereinafter described is merely illustrative of one type of device and should not be taken to limit the scope of the embodiments. As such, it should be appreciated that at least some of the components described below in connection with the electronic device 1600 may be optional and thus in an example embodiment may include more, less or different components than those described in connection with the example embodiment of the FIG. 16. As such, among other examples, the electronic device 1600 could be any of a mobile electronic device or may be embodied in any of the electronic devices, for example, cellular phones, tablet computers, laptops, mobile computers, personal digital assistants (PDAs), mobile televisions, mobile digital assistants, or any combination of the aforementioned, and other types of communication or multimedia devices.

The illustrated electronic device 1600 includes a controller or a processor 1602 (e.g., a signal processor, microprocessor, ASIC, or other control and processing logic circuitry) for performing such tasks as signal coding, data processing, image processing, input/output processing, power control, and/or other functions. An operating system 1604 controls the allocation and usage of the components of the electronic device 1600 and provides support for one or more applications programs, such as a social journaling platform that implement one or more of the innovative features described herein. The applications 1606 may include common mobile computing applications (e.g., telephony applications, email applications, calendars, contact managers, web browsers, messaging applications such as USSD messaging or SMS messaging or SIM Tool Kit (STK) application) or any other computing application.

The illustrated electronic device 1600 includes one or more memory components, for example, a non-removable memory 1608 and/or a removable memory 1610. The non-removable memory 1608 and/or the removable memory 1610 may be collectively known as database in an embodiment. The non-removable memory 1608 can include RAM, ROM, flash memory, a hard disk, or other well-known memory storage technologies. The removable memory 1610 can include flash memory, smart cards, or a Subscriber Identity Module (SIM). The one or more memory components can be used for storing data and/or code for running the operating system 1604. The electronic device 1600 may further include a user identity module (UIM) 1612. The UIM 1612 may be a memory device having a processor built in. The UIM 1612 may include, for example, a subscriber identity module (SIM), a universal integrated circuit card (UICC), a universal subscriber identity module (USIM), a removable user identity module (R-UIM), or any other smart card. The UIM 1612 typically stores information elements related to a mobile subscriber. The UIM 1612 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The electronic device 1600 can support one or more input devices 1620 and one or more output devices 1630. Examples of the input devices 1620 may include, but are not limited to, a touch screen/a display screen 1622 (e.g., capable of capturing finger tap inputs, finger gesture inputs, multi-finger tap inputs, multi-finger gesture inputs, or keystroke inputs from a virtual keyboard or keypad), a microphone 1624 (e.g., capable of capturing voice input), a camera module 1626 (e.g., capable of capturing still picture images and/or video images) and a physical keyboard 1628. Examples of the output devices 1630 may include, but are not limited to a speaker 1632 and a display 1634. Other possible output devices can include piezoelectric or other haptic output devices. Some devices can serve more than one input/output function. For example, the touch screen 1622 and the display 1634 can be combined into a single input/output device.

A wireless modem 1640 can be coupled to one or more antennas (not shown in the FIG. 16) and can support two-way communications between the processor 1602 and external devices, as is well understood in the art. The wireless modem 1640 is shown generically and can include, for example, a cellular modem 1642 for communicating at long range with the mobile communication network, a Wi-Fi compatible modem 1644 for communicating at short range with an external Bluetooth-equipped device or a local wireless data network or router, and/or a Bluetooth-compatible modem 1646. The wireless modem 1640 is typically configured for communication with one or more cellular networks, such as a GSM network for data and voice communications within a single cellular network, between cellular networks, or between the electronic device 1600 and a public switched telephone network (PSTN).

The electronic device 1600 can further include one or more input/output ports 1650, a power supply 1652, one or more sensors 1654 for example, an accelerometer, a gyroscope, a compass, or an infrared proximity sensor for detecting the orientation or motion of the electronic device 1600, a transceiver 1656 (for wirelessly transmitting analog or digital signals) and/or a physical connector 1660, which can be a USB port, IEEE 1294 (FireWire) port, and/or RS-232 port. The illustrated components are not required or all-inclusive, as any of the components shown can be deleted and other components can be added.

The disclosed systems and methods with reference to FIGS. 1 to 16, or one or more operations of the flowchart 1100 and the flow diagrams 300, 500, 600 and 700 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

FIG. 17 is a simplified block diagram of a server system 1700, in which the social journaling platform 116 may be stored, in accordance with one embodiment of the present disclosure. The server system 1700 is an example of the server 114 shown and explained with reference to FIG. 1. The server system 1700 includes a computer system 1705 and one or more databases, such as a database 1710.

The computer system 1705 includes a processor 1715 for executing instructions. Instructions may be stored in, for example, but not limited to, a memory 1720. The processor 1715 may include one or more processing units (e.g., in a multi-core configuration). The processor 1715 is operatively coupled to a communication interface 1725 such that the computer system 1705 is capable of communicating with a remote device such as an electronic device 1735. Example of the electronic device 1735 may include, but is not limited to the electronic devices 104 and 108 shown in FIG. 1.

The processor 1715 may also be operatively coupled to the database 1710. The database 1710 is configured to store primary and secondary journey details associated with a plurality of travel journeys that are created by a plurality of travelers using the social journaling platform 116 supported by the server system 1700 as explained with reference to FIGS. 1 to 16. The database 1710 may also be configured to store profile data associated with profiles of the plurality of travelers, a plurality of aspiring travelers and one or more individuals. The profile data includes, but are not limited to, name, e-mail id, password and contact information. The database 1710 is any computer-operated hardware suitable for storing and/or retrieving data. The database 1710 may include multiple storage units such as hard disks and/or solid-state disks in a redundant array of inexpensive disks (RAID) configuration. The database 1710 may include, but not limited to, a storage area network (SAN) and/or a network attached storage (NAS) system.

In some embodiments, the database 1710 is integrated within the computer system 1705. For example, the computer system 1705 may include one or more hard disk drives as the database 1710. In other embodiments, the database 1710 is external to the computer system 1705 and may be accessed by the computer system 1705 using a storage interface 1730. The storage interface 1730 is any component capable of providing the processor 1715 with access to the database 1710. The storage interface 1730 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 1715 with access to the database 1710.

The memory 1720 is a storage device embodied as one or more volatile memory devices, one or more non-volatile memory devices, and/or a combination of one or more volatile memory devices and non-volatile memory devices, for storing micro-contents information and instructions. The memory 1720 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (Blu-ray® Disc), and semiconductor memories (such as mask ROM, PROM (programmable ROM), EPROM (erasable PROM), flash ROM, RAM (random access memory), etc.).

Various example embodiments offer, among other benefits, techniques for establishing methods and systems for real-time travel journey creation for aspiring and seasoned traveler. The system helps in creating travel journeys for the travelers which makes it easy for the traveler to share all the details associated with a journey in real-time with individuals, such as family and friends. The created travel journeys can also be viewed by aspiring travelers, thereby converting aspiring travelers to actual travelers. The system sends real-time notifications regarding the update performed on the travel journey to all the individuals, with whom the journey is being shared, thereby significantly eliminating the need of sending journey details to each individual separately. The system allows travelers to plan an itinerary first and then start adding updates to the places as they begin their travel, which ensures that the traveler is not missing anything. The system displays the travel journeys which includes all the details associated with the journeys, thereby reducing the chances of cart abandonment due to lack of information. Further, the system learns from stored travel journeys to prepare custom itinerary for the aspiring traveler based on requirement of the aspiring traveler, thereby saving time of the aspiring traveler.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

The present disclosure is described above with reference to block diagrams and flowchart illustrations of method and system embodying the present disclosure. It will be understood that various blocks of the block diagram and flowchart illustrations, and combinations of blocks in the block diagrams and flowchart illustrations, respectively, may be implemented by a set of computer program instructions. These set of instructions may be loaded onto a general-purpose computer, special purpose computer, or other programmable data processing apparatus to cause a device, such that the set of instructions when executed on the computer or other programmable data processing apparatus creates a means for implementing the functions specified in the flowchart block or blocks. Although other means for implementing the functions including various combinations of hardware, firmware and software as described herein may also be employed.

Various embodiments described above may be implemented in software, hardware, application logic or a combination of software, hardware and application logic. The software, application logic and/or hardware may reside on at least one memory, at least one processor, an apparatus or, a non-transitory computer program product. In an example embodiment, the application logic, software or an instruction set is maintained on any one of various conventional computer-readable media. In the context of this document, a “computer-readable medium” may be any non-transitory media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application and\or implementation without departing from the spirit or scope of the claims.

What is claimed is:

1. A method, comprising:
receiving, by a processor, journey details associated with a journey from a traveler device associated with a traveler to initiate creation of a travel journey, the journey details comprising primary journey details;
facilitating, by the processor, updating of the journey details with secondary journey details by the traveler;
storing, by the processor, updated journey details, the updated journey details comprising the primary journey details and the secondary journey details;
creating, by the processor, the travel journey for the traveler based on the updated journey details;
sharing, by the processor, the travel journey with profiles of one or more individuals selected by the traveler;
receiving, by the processor, a journey requirement input from an aspiring traveler;
accessing, by the processor, one or more travel journeys relevant for the aspiring traveler from a database based in part on the journey requirement input; and
electronically creating, by the processor, a custom itinerary for the aspiring traveler based in part on the journey requirement input and the one or more travel journeys.

2. The method as claimed in claim 1, wherein the primary journey details comprises:
name of travel journey;
starting date of journey; and
starting location of journey.

3. The method as claimed in claim 1, wherein the secondary journey details comprises one or more of:
event information;
pictures;
videos;
audios;
ratings;
travel mode;
distance covered;
time spent on travel;
destination information;
date;
journey experience;
travel type;
total expenditure on journey; and
tags.

4. The method as claimed in claim 1, further comprising:
storing, by the processor, the travel journey in the database; and
displaying, by the processor, the travel journey to one or more aspiring travelers.

5. The method as claimed in claim 1, further comprising:
displaying, by the processor, the custom itinerary to the aspiring traveler.

6. The method as claimed in claim 1, further comprising:
creating, by the processor, a traveler profile for each traveler of a plurality of travelers who are interested in sharing their journey experiences with one or more aspiring travelers;
accumulating, by the processor, each travel journey created by each traveler in their traveler profile; and
facilitating, by the processor, display of the each traveler profile to the one or more aspiring travelers, wherein the each traveler profile comprises one or more travel journeys created by each traveler.

7. The method as claimed in claim 6, further comprising:
determining, by the processor, one or more seasoned travelers from the plurality of travelers based on a predefined criteria; and
rewarding, by the processor, the one or more seasoned travelers with one or more gifts.

8. The method as claimed in claim 7, further comprising calculating rewards based at least on a number of views of the travel journey posted on a social journaling platform, number of likes received on the travel journey posted on the social journaling platform and number of addition to favorites on the social journaling platform.

9. The method as claimed in claim 1, wherein saving the updated journey details comprises:
sharing, by the processor, the updated journey details with the profiles of one or more individuals while maintaining privacy of each profile.

10. The method as claimed in claim 1, further comprising facilitating a mentoring session of the traveler with the aspiring traveler on a social journaling platform.

11. The method as claimed in claim 1, further comprising:
facilitating, by the processor, sending of invites by the traveler to the profile of the one or more individuals who are interested in viewing the travel journey.

12. A server system, comprising:
a memory configured to store instructions; and
a processor configured to execute the instructions stored in the memory and thereby cause the server system to perform:
receiving journey details associated with a journey from a traveler device associated with a traveler to initiate creation of a travel journey, the journey details comprising primary journey details;
facilitating updating of the journey details with secondary journey details by the traveler;
storing updated journey details, the updated journey details comprising the primary journey details and the secondary journey details;
creating the travel journey for the traveler based on the updated journey details;
sharing the travel journey with profiles of one or more individuals selected by the traveler;
receiving a journey requirement input from an aspiring traveler;
accessing one or more travel journeys relevant for the aspiring traveler from a database based in part on the journey requirement input; and
electronically creating a custom itinerary for the aspiring traveler based in part on the journey requirement input and the one or more travel journeys.

13. The server system as claimed in claim 12, wherein the primary journey details comprises:
name of travel journey;
starting date of journey; and
starting location of journey.

14. The server system as claimed in claim 12, wherein the secondary journey details comprises one or more of:
event information;
pictures;
videos;
audios;
ratings;
travel mode;
distance covered;
time spent on travel;
destination information;
date;
journey experience;
travel type;
tags; and
total expenditure on journey.

15. The server system as claimed in claim 12, wherein the server system is further configured to:
store the travel journey in the database; and
display the travel journey to one or more aspiring travelers.

16. The server system as claimed in claim 12, wherein the server system is further configured to:
display the custom itinerary to the aspiring traveler.

17. The server system as claimed in claim 12, wherein the server system is further configured to:
create a traveler profile for each traveler of a plurality of travelers who are interested in sharing their journey experiences with one or more aspiring travelers;
accumulate each travel journey created by each traveler in their traveler profile; and
facilitate display of the each traveler profile to the one or more aspiring travelers, wherein the each traveler profile comprises one or more travel journeys created by each traveler.

18. The server system as claimed in claim 17, wherein the server system is further configured to:
determine one or more seasoned travelers from the plurality of travelers based on a predefined criteria; and
reward the one or more seasoned travelers with one or more gifts.

19. The server system as claimed in claim 12, wherein for saving the updated journey details, the server system is further configured to:
share the updated journey details with the profiles of the one or more individuals while maintaining privacy of each profile.

20. The server system as claimed in claim 12, wherein the server system is further configured to:
facilitate sending of invites by the traveler to the profiles of the one or more individuals who are interested in viewing the travel journey.

21. A system comprising:
a database configured to store primary and secondary journey details associated with a plurality of travel journeys created by a plurality of travelers;
a user interface (UI) module in communication with the database, the UI module is configured to present one or more UIs for facilitating creation of travel journey for each traveler, for receiving journey requirement input from each aspiring traveler and for presenting custom itinerary to each aspiring traveler;
a traveler account management module in communication with the UI module and the database, the traveler account management module is configured to create and manage traveler profiles, aspiring traveler profiles and profiles of one or more individuals;
a travel journey creation module in communication with the database, the UI module and the traveler account management module, the travel journey creation module is configured to create travel journeys based on the primary and the secondary journey details provided by the each traveler; and
an itinerary creation engine in communication with the database and the UI module, the itinerary creation engine is configured to create the custom itinerary for each aspiring traveler based in part on the received journey requirement input and one or more travel journeys stored in the database.

22. The system as claimed in claim 21, wherein the system further comprises:
a reward management module in communication with the database and the traveler account management module, the reward management module is configured to determine one or more seasoned travelers from the plurality of travelers based on a predefined criteria and to reward one or more seasoned travelers with one or more gifts;
an update management module is configured to manage and share updates performed on the provided primary and secondary journey details; and
a processing module for providing operating instructions to the UI module, the traveler account management module, the travel journey creation module, the itinerary creation engine, the reward management module and the update management module.
